(19) United States
(12) Patent Application Publication
(10) Pub. No.: US 2025/0211968 A1
(43) Pub. Date: Jun. 26, 2025

(54) LINK LEVEL ROAMING IN A SEAMLESS MOBILITY DOMAIN

(71) Applicant: Cisco Technology, Inc., San Jose, CA (US)

(72) Inventors: Binita Gupta, San Diego, CA (US); Brian Donald Hart, Sunnyvale, CA (US); Malcolm Muir Smith, Richardson, TX (US)

(21) Appl. No.: 18/985,259

(22) Filed: Dec. 18, 2024

Related U.S. Application Data
(60) Provisional application No. 63/612,603, filed on Dec. 20, 2023.

(51) Int. Cl. H04W 8/08; H04W 56/00; H04W 76/15

(52) U.S. Cl. CPC H04W 8/082; H04W 56/0015; H04W 76/15

(57) ABSTRACT

In one aspect, a computer-implemented method includes generating, by a first access point multi-link device (AP MLD), a frame including at least one multi-link reconfiguration element, and sending, by the first AP MLD, the frame to a non-AP MLD to perform a link level roaming. The at least one multi-link reconfiguration element includes at least one delete link operation and at least one add link operation based on which the non-AP MLD performs the link level roaming between the first AP MLD and a second AP MLD of a seamless mobility domain.

### CROSS-REFERENCE TO RELATED APPLICATION

This application claims priority to and the benefit of U.S. Prov. App. No. 63/612,603, filed on Dec. 20, 2023, which is expressly incorporated herein by reference in the entirety.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 (802.11bn) and Wi-Fi 9, each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6/6E included enhanced orthogonal frequency-division multiple access (OFDMA) and target wake time (TWT) mechanisms and included greater frequency and improved overall spectral efficiency and power management and better performance in crowded areas. Wi-Fi 7 (802.11be) delivers speeds of up to 30 Gbps, utilizing multi-band operation, wider bandwidth, advanced MIMO techniques, and improved modulation schemes. Wi-Fi 7 also focuses on reducing latency and enhancing security features.

Wi-Fi 8 (802.11bn) aims to revolutionize wireless connectivity by providing ultra-high reliability enabling rich experiences for QoS demanding applications such as cloud gaming, AR/VR, industrial IoT, wireless TSN etc. Wi-Fi 8 is expected to introduce advancements like seamless roaming, multi-AP coordination for predictable QoS, enhanced power saving and advanced beamforming techniques paving the way for futuristic applications and seamless connectivity experiences.

As Wi-Fi technology continues to evolve, each new Wi-Fi generation brings improvements that address the growing demands of modern networks, including increased device density, higher data rates, lower latency, improved reliability and better overall network performance. These advancements play a crucial role in enabling emerging technologies, supporting the proliferation of smart devices, and transforming the way we connect and communicate in an increasingly interconnected world.

### BRIEF DESCRIPTION OF THE DRAWINGS

To easily identify the discussion of any particular element or act, the most significant digit or digits in a reference number refer to the figure number in which that element is first introduced.

FIG. 1 illustrates a block diagram of an example wireless communication network according to some aspects of the present disclosure.

FIG. 2A illustrates an example of a single floor of building equipped with wireless communication according to some aspects of the present disclosure.

FIG. 2B depicts an illustrative schematic diagram for MLO between an AP MLD with affiliated logical entities and a Non-AP MLD with affiliated logical entities according to some aspects of the present disclosure.

FIG. 3 illustrates an example of a seamless mobility domain according to some aspect of the present disclosure.

FIG. 4 illustrates an example event trace diagram according to some aspects of the present disclosure.

FIG. 5 illustrates an example flow-chart of method operations according to some aspects of the present disclosure.

FIG. 6 illustrates an example of a system for implementing certain aspects of the present disclosure according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

### Abbreviations

Access Point (AP)
Advanced Encryption Standard (AES)
Association and key management (AKM)
Basic service set (BSS)
Extended Service Set (ESS)
Extremely high throughput (EHT)
Fast Transition (FT)
Mobile Device Management (MDM)
Multi-Link Device (MLD)
Multi-link Operation (MLO)
Network Interface Device (NID)
Pairwise Master Key (PMK)
Pairwise Transient Key (PTK)
Robust Security Network Element (RSNE)
Seamless Mobility Domain (SMD)
Service Set Identifier (SSID)
Station (STA)
Wi-Fi Protected Access (WPA)
Wireless Local Area Network (WLAN)
Wireless LAN Controller (WLC)

Mobility Domain MLD (MDM), also Seamless Mobility Domain (SMD) refer to a logical entity including multiple AP MLDs to which a STA (a Wi-Fi client device or non-AP MLD) associates.

As used herein, the term “configured” shall be considered to be used interchangeably with configured and configurable, unless the term “configurable” is explicitly used to distinguish from “configured.” The proper understanding of the term will be apparent to persons of ordinary skill in the art in the context in which the term is used.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum, and power efficiency calls for updates or amendments to the standard to keep up with them. As such, Wi-Fi generally has a new amendment after every few years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency though higher data rates were also included. The next expected update to IEEE 802.11 is coined as Wi-Fi 8. Wi-Fi 8 will attempt to further improve reliability and minimize latency to meet the ever-growing demand for the Internet of Things (IoT), high resolution video streaming, low-latency wireless services, wireless Time Sensitive Networking (TSN) etc.

Multiple Access Point (AP) coordination and transmission in Wi-Fi refers to the management of multiple access points in a wireless network to avoid interference and ensure efficient communication between the STA devices and the network. When multiple access points are deployed in a network—for instance in buildings and office complexes—they operate on the same radio frequency, which can cause interference and degrade the network performance. To mitigate this issue, access points can be configured to coordinate their transmissions and avoid overlapping channels.

Wi-Fi 7 introduced the concept of multi-link operation (MLO), which gives the devices (Access Points (APs) and Stations (STAs)) the capability to operate on multiple links (or even bands) at the same time. MLO introduces a new paradigm to multi-AP coordination which was not part of the earlier coordination approaches. MLO is considered in Wi-Fi-7 to improve the throughput of the network and address the latency issues by allowing devices to use multiple links.

A multi-link device (MLD) may have several “affiliated” devices, each affiliated device having a separate PHY interface, and the MLD having a single link to the Logical Link Control (LLC) layer. In IEEE 802.11be, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11 be™/D0.1, September 2020, section 3.2). Connection(s) with an MLD on the affiliated devices may occur independently or jointly. A preliminary definition and scope of a multi-link element is described in section 9.4.2.247b of aforementioned IEEE 802.11 be draft. An idea behind this information element/container is to provide a way for multi-link devices (MLDs) to share the capabilities of different links with each other and facilitate the discovery and association processes. However, this information element may still be changed, or new mechanisms may be introduced to share the MLO information (e.g., related to backhaul usage).

In multi-link operation (MLO) both STA and APs can possess multiple links that can be simultaneously active. These links may or may not use the same bands/channels.

MLO allows sending PHY protocol data units (PPDUs) on more than one link between a STA and an AP. The links may be carried on different channels, which may be in different frequency bands. Based on the frequency band and/or channel separation and filter performance, there may be restrictions on the way the PPDUs are sent on each of the links.

MLO may include a basic transmission mode, an asynchronous transmission mode, and a synchronous transmission mode.

In a basic transmission mode, there may be multiple primary links, but a device may transmit PPDU on one link at a time. The link for transmission may be selected as follows. The device (such as an AP or a STA) may count down a random back off (RBO) on both links and select a link that wins the medium for transmission. The other link may be blocked by in-device interference. In basic transmission mode, aggregation gains may not be achieved.

In an asynchronous transmission mode, a device may count down the RBO on both links and perform PPDU transmission independently on each link. The asynchronous transmission mode may be used when the device can support simultaneous transmission and reception with bands that have sufficient frequency separation such as separation between the 2.4 GHz band and the 5 GHz band. The asynchronous transmission mode may provide both latency and aggregation gains.

In a synchronous PPDU transmission mode, the device may count down the RBO on both links. If a first link wins the medium, both links may transmit PPDUs at the same time. The transmission at the same time may minimize in-device interference and may provide both latency and aggregation gains.

Multi-AP coordination and MLO are two features directed to improve the performance of Wi-Fi networks as the Multi-AP coordination is directed toward utilizing (distributed) coordination between different APs to reduce inter-Basic Service Set (BSS) interference for improved spectrum utilization in dense deployments, and the MLO supports high data rates and low latency by leveraging flexible resource utilization offered by the use of multiple links for the same device.

### Overview

The present disclosure is directed to providing signaling procedure for triggering roaming in a Multi-Link Operation (MLO) network in which one or more non-AP MLD devices are connected to a wireless network provided using one or more AP MLDs.

In one aspect, a computer-implemented method includes generating, by a first access point multi-link device (AP MLD), a frame including at least one multi-link reconfiguration element, wherein the at least one multi-link reconfiguration element includes at least one add link operation based on which a non-access point multi-link device (non-AP MLD) performs a link level roaming between the first AP MLD and a second AP MLD, wherein both of the first AP MLD and the second AP MLD belong to a seamless mobility domain; and sending, by the first AP MLD, the frame to the non-AP MLD to perform the link level roaming.

In another aspect, the method further includes updating, by the first AP MLD, the frame to further include a roaming time indicating a recommended time of performing the link level roaming, wherein the roaming time being the timing synchronization function (TSF) time of the first AP MLD by which, or at which, the non-AP MLD is expected to perform the link level roaming.

In another aspect, the method further includes determining, by the first AP MLD, the roaming time based on a predicted connectivity loss for the non-AP MLD with the first AP MLD, wherein the first AP MLD is a current AP MLD.

In another aspect, the method further includes updating, by the first AP MLD, the frame to further include a seamless mobility domain identifier that identifies the seamless mobility domain.

In another aspect, the method further includes receiving, from the non-AP MLD at the AP MLD, a confirmation frame specifying either an acceptance or a rejection of the link level roaming corresponding to the at least one multi-link reconfiguration element.

In another aspect, the method further includes wherein the frame includes a first multi-link reconfiguration element and a second multi-link reconfiguration element, the first multi-link reconfiguration element corresponding to a first target AP MLD that is the second AP MLD and the second multi-link reconfiguration element corresponding to a second target AP MLD.

In another aspect, the method further includes receiving, from the non-AP MLD, an acceptance of the link level roaming corresponding to the first multi-link reconfiguration element, and receiving, from the non-AP MLD, a rejection of the link level roaming corresponding to the second multi-link reconfiguration element.

In another aspect, the method further includes transferring, from the first AP MLD to the second AP MLD, context information related to the non-AP MLD for preparing the second AP MLD for the link level roaming.

In another aspect, the method further includes updating, by the first AP MLD, the frame to further include at least one delete link operation in the at least one multi-link reconfiguration element, wherein the at least one delete link operation identifies one or more links of the first AP MLD to be deleted when performing the link level roaming, and wherein the at least one add link operation identifies one or more links of the second AP MLD to be added when performing the link level roaming.

In another aspect, the method further includes wherein the first AP MLD and the second AP MLD are identified in the frame by a respective AP MLD media access control (MAC) address.

In another aspect, the method further includes updating, by the first AP MLD, the frame to further include a roaming command specifying a preference of the first AP MLD for the at least one multi-link reconfiguration element, wherein the preference includes one of the link level roaming being mandatory, the link level roaming being preferred, the link level roaming being suggestive, and the link level roaming being neutral suggestion.

In another aspect, the method further includes updating, by the first AP MLD, the frame to further include a roaming reason field specifying a reason for the preference.

In another aspect, the method further includes wherein the reason for the preference corresponds with one of a high load on the first AP MLD, and a degraded quality of service (QoS) at the first AP MLD.

In another aspect, the method further includes updating, by the first AP MLD, the frame to further include a disassociation imminent field specifying a disassociation time for disassociating the non-AP MLD from the first AP MLD if the non-AP MLD does not perform the link level roaming based on the at least one multi-link reconfiguration element.

In one aspect, an access point multi-link device (AP MLD) includes at least one memory configured to store machine executable instructions and at least one processor communicatively coupled with the at least one memory is disclosed. The at least one processor is configured to execute the machine executable instructions to generate a frame including at least one multi-link reconfiguration element, wherein the at least one multi-link reconfiguration element includes at least one add link operation based on which a non-access point multi-link device (non-AP MLD) performs a link level roaming between the AP MLD and a second AP MLD, wherein both of the AP MLD and the second AP MLD belong to a seamless mobility domain; and send the frame to the non-AP MLD to perform the link level roaming.

In one aspect, a non-transitory computer-readable media (CRM) including machine executable instructions stored thereon is disclosed. The machine executable instructions, when executed by at least one processor of an access point multi-link device (AP MLD), cause the AP MLD to generate a frame including at least one multi-link reconfiguration element, wherein the at least one multi-link reconfiguration element includes at least one add link operation based on which a non-access point multi-link device (non-AP MLD) performs a link level roaming between the AP MLD and a second AP MLD, wherein both of the AP MLD and the second AP MLD belong to a seamless mobility domain; and send the frame to the non-AP MLD to perform the link level roaming.

### Example Embodiments

In Wi-Fi 8, support for seamless or smooth roaming capability is a strong consideration to improve Wi-Fi roaming quality. In particular, to support smooth roaming or mobility in a campus wide Wi-Fi network, Wi-Fi client devices can create an association with the campus-network (also referenced herein as an ESS, an NID, and/or an MDM) instead of creating an association with an individual AP MLD. The ESS might be represented by a mobility domain or a global network (e.g., NID). Further, within a single mobility domain, there can be multiple “sub-mobility domains,” each of multiple “sub-mobility domains” maps to a single campus.

Currently, the Wi-Fi client device creates its association with the ESS network represented by a (sub)Mobility Domain Multi-Link Device (MLD), instead of associating with a single AP MLD within the ESS. Such an architecture can enable the Wi-Fi client device to roam seamlessly between AP MLDs without requiring reassociation and reestablishment of contexts with each new AP MLD. Further, because the Wi-Fi client device associates with the Mobility Domain MLD covering all the AP MLDs of the ESS, such an architecture also reduces roaming time to realize seamless roaming.

When a non-AP MLD is associated with an MDM, it is desirable to enable precise network triggered seamless roaming within the MDM across different AP MLDs or AP links to support seamless roaming as the non-AP MLD roams within the MDM. The 802.11 amendment defines the ML Reconfiguration procedure where a Link Reconfiguration Notify frame can be used to recommend precise link add and link delete operations to a non-AP MLD within the current MLD. However, the Link Reconfiguration Notify frame can be further enhanced to support link reconfiguration recommendations across multiple MLDs, as described in the present disclosure. While various embodiments or aspects are described herein using the Link Reconfiguration Notify frame, any frame can be used, as described herein, to support link reconfiguration recommendations across multiple MLDs.

A Mobility Domain MLD, or an SMD, or an SMD MLD is a logical entity covering AP MLDs of an ESS (e.g., all AP MLDs that are part of a campus ESS network) or a subset of AP MLDs of an ESS (e.g., a floor of a building). A non-AP MLD is associated with an SMD or an SMD MLD (also referenced herein as a Mobility Domain MLD).

By way of an example, a non-AP MLD may be associated with an SMD or an SMD MLD or an MDM such as, an AP MLD1 including an AP1 having a 2.4 GHz link and an AP2 having a 5 GHz link. When AP MLD1 detects that for one of the links (e.g., the 5 GHz link), a Received Signal Strength Indicator (RSSI) is weak for an STA, the AP MLD1 determines a specific roaming target AP3 for that link on a neighboring AP MLD2. The AP MLD1 may use the procedure, as described herein, to initiate the network triggered link level roaming for the non-AP MLD from AP2 to AP3. While RSSI is described here as one example factor for triggering a roaming procedure described below, the present disclosure is not limited thereto and any other known or to be developed factor (some of which are highlighted below) may be used to trigger such roaming procedure.

In some aspects, to support a network triggered seamless link level roaming for an SMD, an SMD MLD, or an MDM including all or a subset of APs or AP MLDs of an ESS or an NID, (e.g., for Multi-User Beamforming and Broadcast Relaying (MBBR)), a current AP MLD sends a frame to indicate following to the non-AP MLD. By way of an example, the frame may be a Link Reconfiguration Notify frame. The frame may include at least one multi-link reconfiguration element.

The at least one multi-link reconfiguration element may include a delete link operation and/or an add link operation. Based upon the at least one multi-link reconfiguration element included in the frame, a non-access point MLD may perform the link level roaming between at least two AP MLDs. Further, the delete link operation identifies one or more link of the current AP MLD to be deleted when performing the link level roaming, and the add link operation identifies one or more links of a new AP MLD to be added when performing the link level roaming. The AP MLD (or the current AP MLD) and the new AP MLD may be identified in the frame by a respective AP MLD media access control (MAC) address in an AP MLD MAC Address field included in the at least one multi-link reconfiguration element.

In some aspects, the frame, such as the Link Reconfiguration Notify frame, may be enhanced to include multiple Reconfiguration Multi-Link elements. Each Reconfiguration Multi-Link element of the multiple Reconfiguration Multi-Link elements corresponds with an AP MLD for which either an add link operation or a delete link operation is intended to be performed by the non-AP MLD. Each AP MLD associated with the add link operation and the current AP MLD associated with the delete link operation are identified in the frame by a respective AP MLD MAC address in AP MLD MAC Address field included in the each Reconfiguration Multi-Link element of the multiple Reconfiguration Multi-Link elements.

In some aspects, the frame, such as the Link Reconfiguration Notify frame, may be used by the AP MLD to recommend a non-AP MLD to roam all of its links to another AP MLD. The AP MLD may indicate deletion of all links with the current AP MLD and addition of one or more links with another AP MLD (or new AP MLD). Further, the roaming time (discussed below) can be negotiated by the AP MLD (or current AP MLD) to transition control states and buffered data to the new AP MLD.

In some aspects, the frame, such as the Link Reconfiguration Notify frame, may also include a roaming time. The roaming time, also referenced herein as a timing synchronization function (TSF) time, may be the time recommended by the AP MLD by which the non-AP MLD is expected or required to perform the link level roaming across two AP MLDs, for example, the current AP MLD and the new AP MLD. By way of an example, the recommended roaming time (or TSF time) may be based on predicted connectivity loss to the current AP MLD (or serving AP MLD). The connectivity loss may be estimated based on trends in the uplink RSSI, for example, as measured by the current AP MLD and neighboring AP MLDs, and/or downlink RSSI such as rate of RSSI decline (e.g. 3 dB/s) as reported by the non-AP MLD to the AP MLD, or via position and/or trajectory reports (e.g., via FTM, UWB) that describe a vector (e.g., position combined with velocity/acceleration) that similarly predicts the rate of RSSI decline or value at a certain time (e.g., via crowd-sourced RSSI heatmaps and/or path-loss prediction). The time at which RSSI (within a margin of error) will become unacceptable to the target data-rate of the connection between the non-AP MLD and the current or serving AP MLD is then used to suggest the roaming time or TSF time. Additionally, or alternatively, the frame may also include one or more RSSI threshold values at which the non-AP MLD should perform link level roaming or request link level roaming.

By way of an example, the roaming time may range from a few milliseconds to a few seconds (e.g., 100 milliseconds to a second but any other applicable time frame determined based on experiments and/or empirical studies within the scope of the present disclosure may be used). Further, the roaming time can be negotiated by the non-AP MLD. In other words, the non-AP MLD may accept the roaming time proposed by the AP MLD, reject the roaming time proposed by the AP MLD, and/or propose a new roaming time to the AP MLD, in a confirmation frame, such as a Link Reconfiguration Notify Confirmation frame, as discussed herein below.

The confirmation frame, such as the Link Reconfiguration Notify Confirmation frame, is sent by the non-AP MLD, to accept or reject the network triggered link level roaming indicated in the Link Reconfiguration Notify frame. By way of an example, the confirmation frame can also indicate a partial accept of the link level recommendation(s) from the AP MLD. For example, if an AP MLD recommended to add two links on a new AP MLD and delete two links on the current AP MLD, the non-AP MLD may accept one link deletion and/or one link addition and indicate such partial acceptance in the confirmation frame. Additionally, or alternatively, in the confirmation frame, the non-AP MLD can accept the roaming time suggested by the AP MLD, reject the roaming time suggested by the AP MLD, or suggest a different roaming time to the AP MLD. Upon receiving the confirmation frame from the non-AP MLD with the different roaming time being suggested or rejection of the roaming time suggested by the AP MLD, the AP MLD can send another frame, such as a Link Reconfiguration Notify frame, with the non-AP MLD suggested roaming time or a different roaming time.

In some aspects, the AP MLD may also provide its preference for the roaming recommendation provided in the frame, for example, the Link Reconfiguration Notify frame by adding a ‘roaming command’ field in the Reconfiguration ML element. By way of an example, the ‘roaming command’ field may be added in the Common Info field to indicate one of the
preferences including Roaming recommendation is Mandatory (i.e., AP's roaming recommendation is mandatory for the STA to follow), Roaming recommendation is Strongly Suggested (i.e., AP's roaming recommendation is strongly suggested for the STA to follow), Roaming recommendation is Preferred (i.e., AP's roaming recommendation is preferred for the STA to follow), and Roaming recommendation is Neutral (i.e., AP's roaming recommendation is provided as neutral to the STA, STA can take into account other factors to pick a roaming candidate). Additionally, or alternatively, additional statistics information indicating probability or likelihood of the STA to roam to one or more target AP MLDs may also be provided in the frame for the STA or non-AP MLD for determining the one or more target AP MLDs for link level roaming.

Additionally, or alternatively, in the Reconfiguration ML element in the Common Info field, a roaming preference value may be provided when the roaming is not mandated to provide a relative preference among roaming recommendation to different APs and/or AP MLDs. In other words, the AP MLD triggered roaming recommendation can include multiple AP MLDs for roaming as alternate roaming options with a preference indicated for link level roaming to each of the multiple AP MLDs.

Further, a Roaming Reason code field may also be provided to further indicate the reason for specific roaming recommendation. For example, if the indicated roaming recommendation is Mandatory, then the roaming reason code may include, for example, ‘high load on current BSS’ or ‘degraded QoS on current BSS’ as a reason for the suggested mandatory roaming recommendation.

In some aspects, the frame, such as the Link Reconfiguration Notify frame, may be enhanced to include a Disassociation Imminent field. The Disassociated Imminent field may indicate that a disassociation is imminent if the non-AP MLD does not act upon the AP MLD's suggested recommendation of link level roaming in the frame. The Disassociated Imminent field may be a Boolean value field; a value of 1 may suggest that the disassociation is imminent, and a value of 0 may suggest that the disassociation is not imminent, or vice versa. Additionally, or alternatively, the frame may also indicate a Disassociation Time when the disassociation is likely to happen. The Disassociation Time may be presented as an absolute time or a duration from the time the frame is sent. By way of an example, information associated with the Disassociation Imminent field may be included in the Common Info field in the Reconfiguration ML element.

In some aspects, a new element may be included in the frame to provide Disassociation Imminent related information, a roaming command, and/or a roaming preference, described in the present disclosure. Upon receiving the frame, such as the Link Reconfiguration Notify frame, by the non-AP MLD, the non-AP MLD may perform roaming based on the ‘roaming command’ indication included in the frame. As described herein, the non-AP MLD may send a confirmation frame, such as the Link Reconfiguration Notify Confirmation frame, to accept or reject the network triggered link level roaming.

In some aspects, the frame may also include a Single-Mode, Multi-Data-rate Extended (SMDE) element to indicate that the roaming is for a given SMD. Further, for a Roaming AP MLD, an element indicating the Roaming AP MLD info, for example, RAM MAC address, etc., may also be added in the frame.

Accordingly, various disclosed aspects herein provide link reconfiguration recommendations across multiple AP MLDs, and, thereby, support precise network triggered seamless roaming across AP MLDs or links for seamless roaming as the non-AP MLD moves within the Mobility Domain MLD.

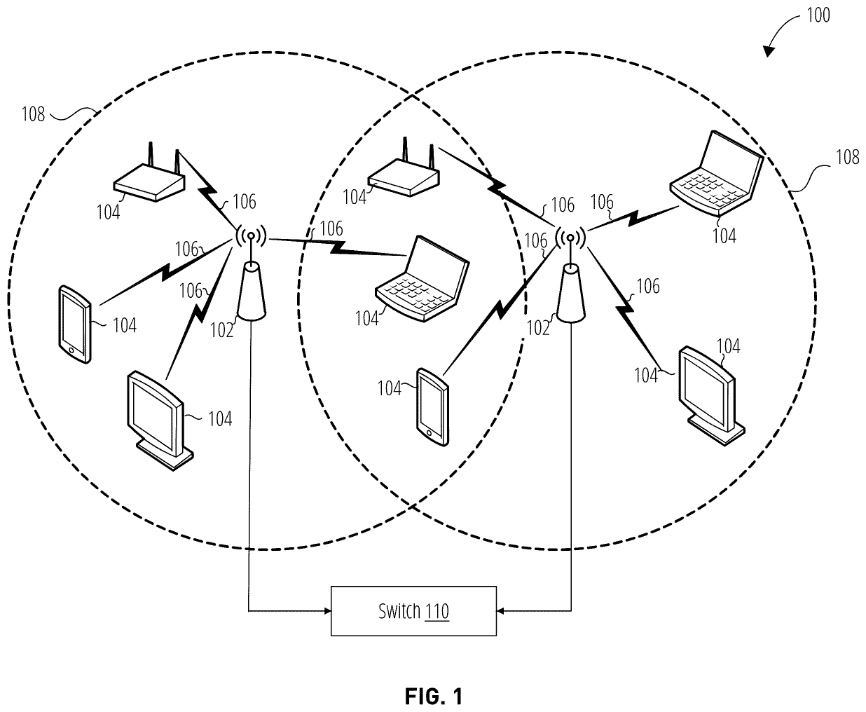

FIG. 1 illustrates a block diagram of an example wireless communication network according to some aspects of the present disclosure. According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the wireless communication network 100 may implement future versions and amendments of the wireless communication protocol standards and amendments thereof such as 802.11bn and be modified according to the present disclosure to include the features contained herein.

Wireless communication network 100 may include numerous wireless communication devices such as an AP actor, which can be one or more of a non-MLD AP, an AP affiliated with an AP MLD, and/or an AP MLD. In the examples presented herein, the AP actor can exclude an upper UMAC. Therefore, the AP actor can include the lower UMAC, LMAC, and/or PHY. Additionally, the WLAN can include one or more of STA actors 104, which can be one or more of a non-MLD STA, a STA affiliated with a non-AP MLD, and/or a non-AP MLD. As illustrated, wireless communication network 100 also may include multiple AP actors such as AP actors 102 (may also be referred to as simply AP). AP actors 102 can be coupled to one another through a switch 110. While AP actors 102 are shown as being coupled to one another through switch 110, wireless communication network 100 can provide another device that allows the coupling of multiple AP actors.

Each of the STA actors 104 also may be referred to as a mobile station (MS), a mobile device, a mobile handset, a wireless handset, an access terminal (AT), a user equipment (UE), a subscriber station (SS), client, or a subscriber unit, among other examples. The STA actors 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STA actors 104 can be referred to as clients and/or client devices.

Any one of AP actors 102 and an associated set of STA actors (e.g., STA actors 104) may be referred to as a basic service set (BSS), which is managed by a respective AP actor of AP actors 102. FIG. 1 additionally shows an example coverage area 108 of the each of AP actors 102, which may represent a basic service area (BSA) of wireless communication network 100. As illustrated, three of STA actors 104 are within the BSA of each of AP actors 102. The BSS may be identified to users by a service set identifier (SSID), where the BSS might be one of many in the SSID. The BSS may be identified to other devices by a unique (or substantially unique) basic service set identifier (BSSID). One or more of AP actors 102 periodically broadcasts beacon frames (“beacons”) including the BSSID to enable STA actors 104 within wireless range of AP actors 102 to “associate” or re-associate with AP actors 102 to establish a respective communication link of communication links 106 (hereinafter also referred to as a “Wi-Fi link”), or to maintain communication links 106, with AP actors 102. For example, the beacons may include an identification of a primary channel used by respective AP actor of AP actors 102 as well as a timing synchronization function for establishing or maintaining timing synchronization with AP actors 102. AP actors 102 may provide communication links 106 to STA actors 104 and therefore access to external networks. While the example has been described in regard to AP actors 102 and STA actors 104, the present disclosure extends such that an AP actor may provide access to external networks to various STA actors in a WLAN via communication links 106.

To establish communication links 106 with any one of AP actors 102, each of STA actors 104 is configured to perform passive or active scanning operations (“scans”) on frequency channels in one or more frequency bands (for example, the 2.4 GHz, 5 GHz, 6 GHz or 60 GHz bands). To perform passive scanning, STA actors 104 listen for beacons, which are transmitted by a respective AP actor of AP actors 102 at or near a periodic time referred to as the target beacon transmission time (TBTT) (measured in time units (TUs) where one TU may be equal to 1024 microseconds (μs)). To perform active scanning, STA actors 104 generate and sequentially transmits probe requests on each channel to be scanned and listens for probe responses from AP actors 102. STA actors 104 may be configured to identify or select an AP and thence a selected AP actor of AP actors 102 with which to associate based on the scanning information obtained through the passive or active scans, and to perform authentication and association operations to establish the communication links 106 with the selected AP actor of AP actors 102. The selected AP actor of AP actors 102 assigns an association identifier (AID) to STA actors 104 at the culmination of the association operations, which selected AP actor of AP actors 102 uses to improve the efficiency of certain signaling to the STA actors 104.

The present disclosure modified the WLAN radio and baseband protocols for the PHY and medium access controller (MAC) layers. AP actors 102 and STA actors 104 transmit and receive wireless communications (hereinafter also referred to as “Wi-Fi communications”) to and from one another in the form of PHY protocol data units (PPDUs). AP actors 102 and STA actors 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

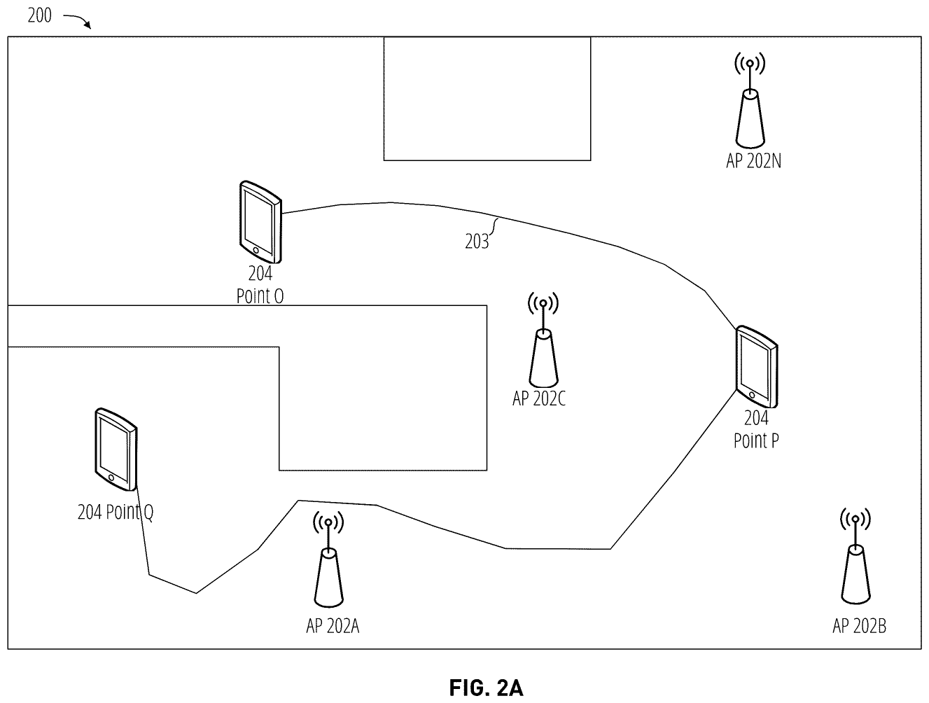

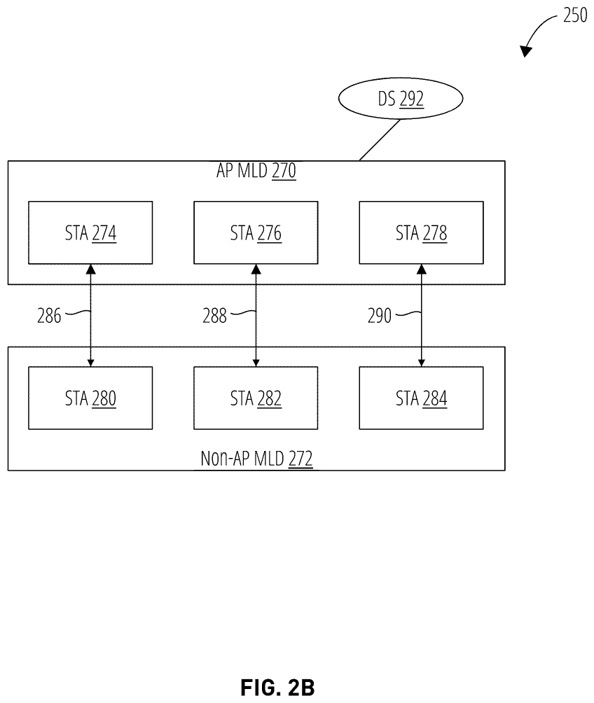

FIG. 2A illustrates an example of a single floor of building equipped with wireless communication according to some aspects of the present disclosure. While only a single floor 200 is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more AP actors. As illustrated, the single floor 200 includes AP actors 202A, 202B, 202C, 202N. Each of the AP actors 202A, 202B, 202C, 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP actor of AP actors 202A, 202B, 202C, 202N may substantially overlap with the coverage of another AP actor of the AP actors 202A, 202B, 202C, 202N.

As illustrated by line 203, STA actor 204 can move from point O to point P to point Q. When a STA actor 204 is moving around on a given floor, one or more of AP actors 202A, 202B, 202C, 202N can be considered to be nearest to STA actor 204. Nearest as used in relation to AP actors 202A, 202B, 202C, 202N and STA actor 204 can include being physically nearest (for example, a Euclidean distance on the floor) and/or pathloss-nearest (for example, having the lowest wireless attenuation (pathloss) between AP actor, among all the AP actors, and STA actor). Additionally, the pathloss-nearest approach can be used to reduce the likelihood of connection between an AP actor on a floor above or below STA actor 204. The location of the AP actor on the floor above or below might be closer in a Euclidean sense, but also not be a desirable AP for the connection of the device or station due to the floor location and/or possible signal interruption. The location of the AP actor on the floor above or below might be closer in a straight line and/or Euclidean sense, but also not be a desirable AP for the connection of the device or station due to the floor location and/or possible signal interruption. Additionally, the coverage of one or more AP actors can at least partially overlap with the coverage of one or more other AP actors. The present disclosure provides for selecting the AP actor and/or providing a communication pathway from one or more STA actors through one or more AP actors.

FIG. 2B depicts an illustrative schematic diagram for MLO between an AP MLD with affiliated logical entities and a Non-AP MLD with affiliated logical entities according to some aspects of the present disclosure.

Referring to FIG. 2B, schematic diagram 250 may include two multi-link logical entities AP MLD 270 and Non-AP MLD 272. AP MLD 270 may include physical and/or logical affiliated AP such as AP 274, AP 276, and AP 278 operating in different channels and typically different frequency bands (e.g., 2.4 GHz, 5 GHz, and 6 GHz). AP 274, AP 276, and AP 278 may be the same as or similar to any one of the APs described above. Non-AP MLD 272 may include STA 280, STA 282, and STA 284, which may be the same as or similar to any of the STAs as described herein.

AP 274 may communicate with STA 280 via link 286. AP 276 may communicate with STA 282 via link 288. AP 278 may communicate with STA 284 via link 290.

AP MLD 270 is shown in FIG. 2B to have access to a distribution system (DS) such as DS 292, which is a system used to interconnect a set of BSSs to create an extended service set (ESS).

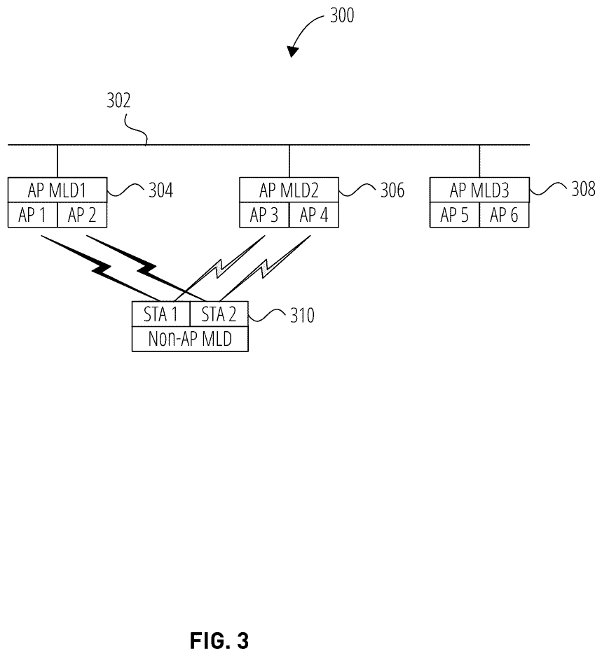

It should be understood that although the example shows three logical entities within the AP MLD and the three logical entities within the Non-AP MLD, this is merely for illustration purposes and that other numbers of logical entities within each of the AP MLD and Non-AP MLD may be envisioned. The example Wi-Fi systems and MLO described above with reference to FIGS. 1 and 2A-2B provide examples of simplified and example systems of the present disclosure. Additional details of the present disclosure are provided in relation to FIGS. 3, 4, and 5.

FIG. 3 illustrates an example of a seamless mobility domain according to some aspect of the present disclosure.

FIG. 3 illustrates an example architecture of a Seamless Mobility Domain (SMD) shown as SMD 300 that includes a DS 302 (may be the same as the DS 292) that is a logically connected entity that includes AP MLD1 304, AP MLD2 306, and AP MLD3 308, all of which can form an ESS (e.g., all AP MLDs which are part of a campus ESS network). SMD 300 also shows a non-AP MLD 310 that may be connected to AP MLD1 304.

AP MLD1 304 may include one or more APs such as AP1 and AP2. AP1 and AP2 may be different physical APs (or AP interfaces) co-located in AP MLD1 304. Similarly, AP MLD2 306 may include one or more APs such as AP3 and AP4. AP3 and AP4 may be different physical APs (or AP interfaces) co-located in AP MLD2 306. Similarly, AP MLD3 308 may include one or more APs such as AP5 and AP6. AP5 and AP6 may be different physical APs (or AP interfaces) co-located in AP MLD3 308. The number of AP MLDs and/or the number of respective APs of each AP MLD is not limited to the example numbers shown in FIG. 2B and may include more or less.

In one example, AP MLD1 304, AP MLD2 306, and AP MLD3 308 may be located in different geographical locations (e.g., different rooms of the same building, different floors of the same building, different buildings of the same campus or area, etc.).

Non-AP MLD 310 may be any known or to be developed device capable of establishing one or more wireless communication links with one or more of AP MLD1 304, AP MLD2 306, and/or AP MLD3 308. As a non-limiting example, non-AP MLD 310 may be a mobile device having two wireless interfaces, each of which may correspond to one of STA1 or STA2. In one example, each one of STA1 and STA2 may operate on a different link (e.g., 5 GHz for STA1 and 6 GHz for STA2). The number of Non-AP MLDs and/or STAs associated with each is not limited to that shown in FIG. 3 and may be more or less.

As shown in FIG. 3, the non-AP MLD 310 is associated with the SMD 300 with multiple links setup with the AP MLD1 304 (for example, 2.4 GHz link with the AP1 for the STA1 and 5 GHz link with the AP2 for the STA2). For one of the links (for example, 2.4 GHz), the AP MLD 310 may detect a weak RSSI. As a result, the AP MLD 310 determines a specific roaming target AP3 of AP MLD2 306 for that link to Switch to. Similarly, the same process may be performed for the other link (for example, the 5 GHz) to Switch to a link with STA4 on the AP MLD2 205.

In order to support seamless link level roaming for an ESS/NID/MDM/SMD (e.g., for MBBR), by way of an example, seamless link level roaming may be initiated by the current AP MLD (e.g., AP MLD1 304). Alternatively, seamless link level roaming may be based upon a request received from the Non-AP MLD (e.g., non-AP MLD 310). The current AP MLD (may also be referred to as the Source AP MLD) may send a frame, for example, a BSS Transition Management Request frame or any other known or to be developed management frame, to indicate to the Non-AP MLD one or more of: a) one or more ‘delete link’ operations for link(s) of the current AP MLD (in the old MLD's link ID space); and/or b) one or more ‘add link’ operations for link(s) of a new Target AP MLD such as the AP MLD2 306 (in the new MLD's link ID space), wherein the current AP MLD may indicate ‘add link’ operations for multiple candidate Target AP MLDs.

As described herein, the link space can be defined and identified corresponding to each AP MLD by the respective AP MLD MAC Address field included in the Reconfiguration ML element. Accordingly, the frame, such as the BSS Transition Management Request frame, may include multiple Reconfiguration Multi-Link elements. Each Reconfiguration Multi-Link element of the multiple Reconfiguration Multi-Link elements corresponds with each AP MLD for which either a link add, or a link delete operation is indicated in the frame. Further, as described herein, the link add operation may be indicated for multiple roaming candidate Target AP MLDs within the Link Reconfiguration Notify frame. In the Reconfiguration Multi-Link element, the MLD MAC Address may be set to the MLD MAC Address of the AP MLD for which the link add or the link delete operation is indicated.

Support for seamless/smooth roaming capability is a consideration for Wi-Fi 8 to improve Wi-Fi roaming quality. To support smooth roaming/mobility in network (e.g., a geographically dispersed network such as on a campus wide Wi-Fi network), clients can create association with the campus-network/ESS instead of with an individual AP MLD. The ESS might be represented by a mobility domain or, in the case that the network is a global network, then there can be multiple “sub-mobility domains” within a mobility domain, each of which can map to a single campus.

A client such as the non-AP MLD 310 currently creates its association with the ESS network such as the SMD 300, instead of associating with a single AP MLD (e.g., AP MLD1 304, AP MLD2 306, and/or AP MLD3 308) within the ESS. Such an architecture will enable a client to roam seamlessly between AP MLDs without requiring (re)association and reestablishment of contexts with each new AP MLD, since the client associates with the SMD covering all the AP MLDs of the ESS. Such an architecture can significantly reduce roaming time to realize seamless roaming. Signaling procedures to enable such seamless roaming are described in the present disclosure.

In order to support seamless link level roaming for an ESS/NID/MDM/SMD (e.g., for MBBR). By way of an example, seamless link level roaming may be initiated by the current AP MLD. Alternatively, seamless link level roaming may be based upon a request received from the non-AP MLD. The current AP MLD (or source AP MLD) sends a frame, for example, a Link Reconfiguration Notify frame or another equivalent management frame, to indicate to the non-AP MLD one or more of: a) one or more ‘delete link’ operations for link(s) of the current AP MLD (in the old MLD's link ID space); and/or b) one or more ‘add link’ operations for link(s) of a new target AP MLD (in the new MLD's link ID space), wherein the current AP MLD may indicate ‘add link’ operations for multiple candidate target AP MLDs.

As described herein, the link space can be defined and identified corresponding to each AP MLD by the respective AP MLD MAC Address field included in the Reconfiguration ML element. Accordingly, the frame, such as the Link Reconfiguration Notify frame, may include multiple Reconfiguration Multi-Link elements. Each Reconfiguration Multi-Link element of the multiple Reconfiguration Multi-Link elements corresponds with each AP MLD for which either a link add, or a link delete operation is indicated in the frame. Further, as described herein, the link add operation may be indicated for multiple roaming candidate target AP MLDs within the Link Reconfiguration Notify frame. In the Reconfiguration Multi-Link element, the MLD MAC Address may be set to the MLD MAC Address of the AP MLD for which the link add or the link delete operation is indicated.

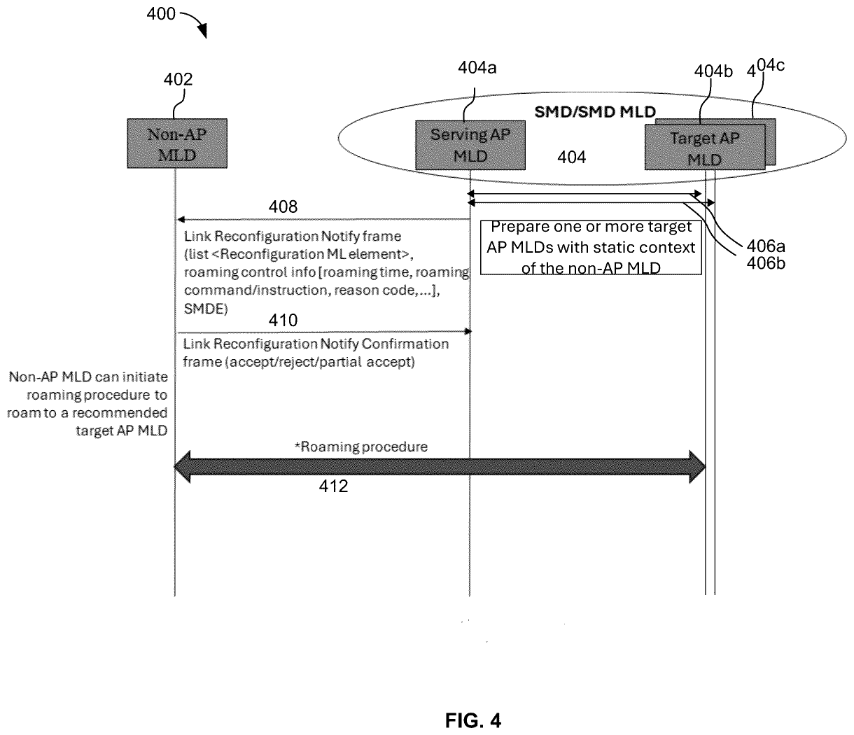

FIG. 4 illustrates an example event trace diagram 400 according to some aspects of the present disclosure. The event trace diagram 400 shows frames communicated between a non-AP MLD 402 and an SMD (or an SMD MLD) such as SMD 404. By way of an example, the SMD 404 may include a current AP MLD (or a serving AP MLD) such as current AP MLD 404a and one or more target AP MLDs such as target AP MLD 404b and target AP MLD 404c. As described herein, the non-AP MLD 402 may be currently being served by the current AP MLD 404a.

However, for various reasons as described herein, for the non-AP MLD 402 associated with the SMD (or the SMD MLD) 404, it is desirable to enable precise network triggered seamless roaming within the SMD 404 across different AP MLDs such as AP MLD 404b and AP MLD 404c, or AP links to support seamless roaming as the non-AP MLD 402 roams within the SMD 404. Upon determining by the current AP MLD 404a that the non-AP MLD 402 needs (or is preferred) to roam to one or more other AP MLDs such as target AP MLD 404b and/or target AP MLD 404c, the current AP MLD 404a may communicate with one or more target AP MLDs such as target AP MLD 404b and/or target AP MLD 404c, as shown in FIG. 4, to prepare the one or more target AP for the network triggered link level roaming. The current AP MLD 404a may provide static context of the non-AP MLD 402 in frames 406a and 406b communicated with target AP MLDs such as target AP MLD 404b and/or target AP MLD 404c, respectively.

Further, the current AP MLD 404a may send a frame 408 to the non-AP MLD 402. As described herein, the frame 408 may be a Link Reconfiguration Notify frame including at least one multi-link reconfiguration element.

As described herein, the at least one multi-link reconfiguration element may include a delete link operation and/or an add link operation. Based upon the at least one multi-link reconfiguration element included in the frame 408, a non-AP MLD 402 may perform the link level roaming between at least two AP MLDs. Further, the delete link operation identifies one or more link of the current AP MLD 404a to be deleted when performing the link level roaming, and the add link operation identifies one or more links of a new AP MLD (e.g., target AP MLD 404b and/or target AP MLD 404c) to be added when performing the link level roaming. The current AP MLD 404a and the target AP MLD 404b and/or target AP MLD 404c (target AP MLD 404b and target AP MLD 404c may be referred to as new AP MLDs) may be identified in the frame by a respective AP MLD media access control (MAC) address in an AP MLD MAC Address field included in the at least one multi-link reconfiguration element.

In some aspects, the frame 408 may be enhanced to include multiple Reconfiguration Multi-Link elements. Each Reconfiguration Multi-Link element of the multiple Reconfiguration Multi-Link elements corresponds with an AP MLD for which either an add link operation or a delete link operation is intended to be performed by the non-AP MLD 402. Each AP MLD (e.g., target AP MLD 404b and/or target AP MLD 404c) associated with the add link operation and the current AP MLD 404a associated with the delete link operation are identified in the frame 408 by a respective AP MLD MAC address in AP MLD MAC Address field included in the each Reconfiguration Multi-Link element of the multiple Reconfiguration Multi-Link elements.

In some aspects, the frame 408 may be used by the current AP MLD 404a to recommend a non-AP MLD 402 to roam all of its links to another target AP MLD 404b or 404c. The current AP MLD 404a may indicate deletion of all links with the current AP MLD 404a and addition of one or more links with another AP MLD (or new AP MLD) such as target AP MLD 404b and/or target AP MLD 404c. Further, the roaming time can be negotiated by the current AP MLD 404a to transition control states and buffered data to the new AP MLD (e.g., target AP MLD 404b and/or target AP MLD 404c).

In some aspects, the frame 408 may also include a roaming time. As described herein, the roaming time (or TSF time), may be the time recommended by the current AP MLD 404a by which the non-AP MLD 402 is expected or required to perform the link level roaming across two AP MLDs, for example, the current AP MLD 404a and the target AP MLD 404b and/or target AP MLD 404c. By way of an example, the roaming time may range from a few milliseconds to a few seconds (e.g., 100 milliseconds to a second but any other applicable time frame determined based on experiments and/or empirical studies within the scope of the present disclosure may be used). Further, the roaming time can be negotiated by the non-AP MLD 402. In other words, the non-AP MLD 402 may accept the roaming time proposed by the current AP MLD 404a, reject the roaming time proposed by the current AP MLD 404a, and/or propose a new roaming time to the current AP MLD 404a, in a confirmation frame 410, such as a Link Reconfiguration Notify Confirmation frame, as described herein.

The confirmation frame 410 is sent by the non-AP MLD 402 upon receiving the frame 408. As described herein, the non-AP MLD 402 may indicate, to the current AP MLD 404a, acceptance, rejection, or partial acceptance of the link level roaming recommendation(s) included in the frame 408. For example, if a current AP MLD 404a recommended to add two links on a target AP MLD 404b and/or target AP MLD 404c and delete two links on the current AP MLD 404a, the non-AP MLD 402 may accept one link deletion and/or one link addition and indicate such partial acceptance in the confirmation frame 410.

Additionally, or alternatively, in the confirmation frame 410, the non-AP MLD 402 can accept the roaming time suggested by the current AP MLD 404a, reject the roaming time suggested by the AP MLD 404a, or suggest a different roaming time to the current AP MLD 404a. As described herein, upon receiving the confirmation frame 410 from the non-AP MLD 402 with the different roaming time being suggested or rejection of the roaming time suggested by the current AP MLD 404a, the current AP MLD 404a can send another frame (not shown in FIG. 4), such as another Link Reconfiguration Notify frame, with the non-AP MLD 402 suggested roaming time or a different roaming time.

In some aspects, the current AP MLD 404a may also provide its preference for the roaming recommendation provided in the frame 408. By way of an example, a ‘roaming command’ field in the Reconfiguration ML element may be added for the frame 408. By way of an example, the ‘roaming command’ field may be added in the Common Info field to indicate one of the preferences including Roaming recommendation is Mandatory (i.e., current AP MLD 404a's roaming recommendation is mandatory for the STA or non-AP MLD 402 to follow), Roaming recommendation is Strongly Suggested (i.e., current AP MLD 404a's roaming recommendation is strongly suggested for the STA or non-AP MLD 402 to follow), Roaming recommendation is Preferred (i.e., current AP MLD 404a's roaming recommendation is preferred for the STA or non-AP MLD 402 to follow), and Roaming recommendation is Neutral (i.e., current AP MLD 404a's roaming recommendation is provided as neutral to the STA or non-AP MLD 402, and the STA or non-AP MLD 402 can take into account other factors to accept or reject the suggested roaming candidate).

Additionally, or alternatively, in the Reconfiguration ML element in the Common Info field, a roaming preference value may be provided when the roaming is not mandated to provide a relative preference among roaming recommendation to different APs and/or AP MLDs. Further, a Roaming Reason code field may also be provided to further indicate the reason for specific roaming recommendation. For example, if the indicated roaming recommendation is Mandatory, then the roaming reason code may include, for example, ‘high load on current BSS’ ‘degraded QoS on current BSS’ as a reason for the suggested mandatory roaming recommendation.

In some aspects, the frame 408 may be enhanced to include a Disassociation Imminent field. The Disassociated Imminent field may indicate that a disassociation is imminent if the non-AP MLD 402 does not act upon the current AP MLD 404a's suggested recommendation of link level roaming in the frame 408. The Disassociated Imminent field may be a Boolean value field; a value of 1 may suggest that the disassociation is imminent, and a value of 0 may suggest that the disassociation is not imminent, or vice versa. Additionally, or alternatively, the frame 408 may also indicate a Disassociation Time when the disassociation is likely to happen. The Disassociation Time may be presented as an absolute time or a duration from the time the frame is sent. By way of an example, information associated with the Disassociation Imminent field may be included in the Common Info field in the Reconfiguration ML element.

In some aspects, a new element may be included in the frame 408 to provide Disassociation Imminent related information, a roaming command, and/or a roaming preference, described in the present disclosure. Upon receiving the frame 408 by the non-AP MLD 402, the non-AP MLD 402 may perform roaming procedure 412 (may also be referred to as link-level roaming procedure) based on the ‘roaming command’ indication included in the frame 408. Further, as described herein, the non-AP MLD 402 may send a confirmation frame 410 to accept or reject the link level roaming such as, the network triggered link level roaming. While performing the roaming procedure 412, the non-AP MLD 402 may establish links with one or more target AP MLDs such as target AP MLD 404b and/or target AP MLD 404c.

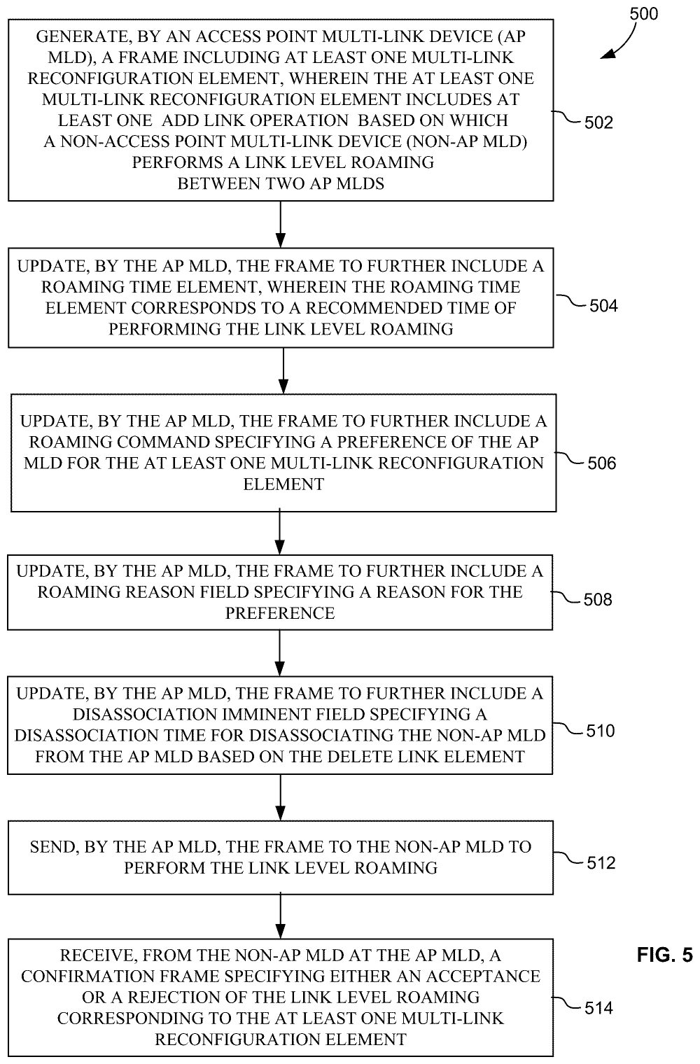

FIG. 5 illustrates an example flow-chart 500 of method operations according to some aspects of the present disclosure. The method operations include generating 502 a frame 408 including at least one multi-link reconfiguration element. The frame 408 is generated by current AP MLD 404a and includes at least one multi-link reconfiguration element. The at least one multi-link reconfiguration element may include at least one add link operation based on which the non-AP MLD 402 performs a link level roaming between two AP MLDs, for example, current AP MLD (or the first AP MLD) 404a and target AP MLD (or a second AP MLD) 404b, or current AP MLD 404a and target AP MLD (or a third AP MLD) 404c. As described herein, the link level roaming may also be performed from current AP MLD 404a to target AP MLD 404b and/or target AP MLD 404c. By way of an example, the add link operation may identify one or more links of a new AP MLD, for example, target AP MLD 404b and/or target AP MLD 404c, to be added when performing the link level roaming. Additionally, or alternatively, the at least one multi-link reconfiguration element may include at least one delete link operation. The at least one delete link operation may identify one or more links of the current AP MLD to be deleted when performing the link level roaming.

The method operations may include updating 504, by the current AP MLD 404a, the frame 408 to further include a roaming time element. As described herein, the roaming time element (also referenced herein as a TSF time) corresponds to a recommended time of performing the link level roaming.

The method operations may include updating 506, by the current AP MLD 404a, the frame 408 to further include a roaming command specifying a preference of the current AP MLD 404a for the at least one multi-link reconfiguration element. By way of an example, the ‘roaming command’ field may be added in the Common Info field to indicate one of the preferences including Roaming recommendation is Mandatory, Roaming recommendation is Strongly Suggested, Roaming recommendation is Preferred, and Roaming recommendation is Neutral.

The method operations may include updating 508, by the current AP MLD 404a, the frame 408 to further include a Roaming Reason field (or a Roaming Reason code field) specifying a reason for the preference. For example, if the indicated roaming recommendation is Mandatory, then the Roaming Reason code field may include, for example, ‘high load on current BSS’ or ‘degraded QoS on current BSS’ as a reason for the suggested mandatory roaming recommendation. The method operations may include updating 510, by the current AP MLD 404a, the frame 408 to further include a disassociation imminent field specifying a disassociation time for disassociating the non-AP MLD from the AP MLD based on the delete link operation.

The method operations include sending 512, by the current AP MLD 404a, the frame 408 to the non-AP MLD 402 to perform the roaming procedure 412. The frame 408 may include a first multi-link reconfiguration element and a second multi-link reconfiguration element. The first multi-link reconfiguration element may correspond with a first target AP MLD, for example, target AP MLD 404b, and the second multi-link reconfiguration element may correspond with a second target AP MLD, for example, target AP MLD 404c.

Additionally, the method operations may also include receiving 514, by the current AP MLD 404a from the non-AP MLD 402, a confirmation frame 410. The confirmation frame 410 specifies whether the non-AP MLD 402 accepts or rejects the link level roaming suggested in the frame 408 corresponding to the at least one multi-link reconfiguration element included in the frame 408. Further, as described herein, the non-AP MLD 402 may send, to the current AP MLD 404a, an acceptance of the link level roaming corresponding to the first multi-link reconfiguration element and a rejection of the link level roaming corresponding to the second multi-link reconfiguration element.

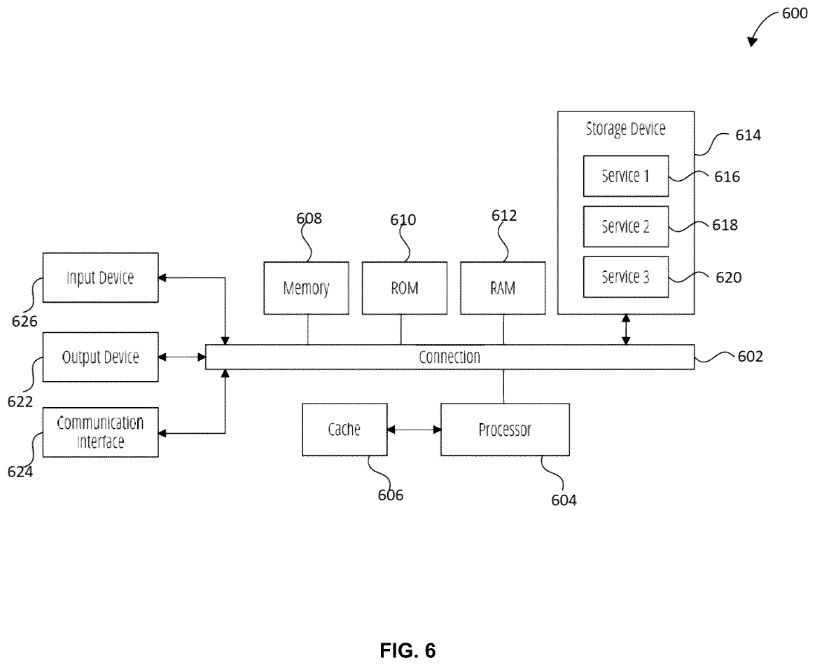

FIG. 6 shows an example of computing system 600, which can be for example any computing device making up the elements of FIG. 1, FIG. 2A, FIG. 2B, FIG. 3, FIG. 4, FIG. 5, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU) or processor such as processor 604 and connection 602 that couples various system components including system memory 608, such as read-only memory (ROM) such as ROM 610 and random-access memory (RAM) such as RAM 612 to processor 604. Computing system 600 can include a cache of high-speed memory 606 connected directly with, in close proximity to, or integrated as part of processor 604.

Processor 604 can include any general-purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a STA device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method comprising:
generating, by a first access point multi-link device (first AP MLD), a frame including at least one multi-link reconfiguration element, wherein the at least one multi-link reconfiguration element includes at least one add link operation based on which a non-access point multi-link device (non-AP MLD) performs a link level roaming between the first AP MLD and a second AP MLD, wherein both of the first AP MLD and the second AP MLD belong to a seamless mobility domain; and
sending, by the first AP MLD, the frame to the non-AP MLD to perform the link level roaming.

2. The computer-implemented method of claim 1, further comprising:
updating, by the first AP MLD, the frame to further include a roaming time indicating a recommended time of performing the link level roaming, wherein the roaming time is a timing synchronization function (TSF) time of the first AP MLD by which the non-AP MLD is expected to perform the link level roaming.

3. The computer-implemented method of claim 1, further comprising:
determining, by the first AP MLD, a roaming time indicating a recommended time of performing the link level roaming, wherein the roaming time is determined based on a predicted connectivity loss for the non-AP MLD with the first AP MLD, wherein the first AP MLD is a current AP MLD to which the non-AP MLD is connected.

4. The computer-implemented method of claim 1, further comprising:
updating, by the first AP MLD, the frame to further include a seamless mobility domain identifier that identifies the seamless mobility domain.

5. The computer-implemented method of claim 1 further comprising:
receiving, from the non-AP MLD at the first AP MLD, a confirmation frame specifying either an acceptance or a rejection of the link level roaming corresponding to the at least one multi-link reconfiguration element.

6. The computer-implemented method of claim 1, wherein,
the frame includes a first multi-link reconfiguration element and a second multi-link reconfiguration element, the first multi-link reconfiguration element corresponding to a first target AP MLD that is the second AP MLD and the second multi-link reconfiguration element corresponding to a second target AP MLD, and
the computer-implemented method further comprises:
receiving, from the non-AP MLD, an acceptance of the link level roaming corresponding to the first multi-link reconfiguration element; and
receiving, from the non-AP MLD, a rejection of the link level roaming corresponding to the second multi-link reconfiguration element.

7. The computer-implemented method of claim 1, further comprising:
updating, by the first AP MLD, the frame to further include at least one delete link operation in the at least one multi-link reconfiguration element,
wherein the at least one delete link operation identifies one or more links of the first AP MLD to be deleted when performing the link level roaming, and wherein the at least one add link operation identifies one or more links of the second AP MLD to be added when performing the link level roaming.

8. The computer-implemented method of claim 1 further comprising:
updating, by the first AP MLD, the frame to further include a roaming command specifying a preference of the first AP MLD for the at least one multi-link reconfiguration element, wherein the preference includes one of the link level roaming being mandatory, the link level roaming being preferred, the link level roaming being suggestive, and the link level roaming being neutral suggestion.

9. The computer-implemented method of claim 8 further comprising:
updating, by the first AP MLD, the frame to further include a roaming reason field specifying a reason for the preference.

10. The computer-implemented method of claim 1 further comprising:
updating, by the first AP MLD, the frame to further include a disassociation imminent field specifying a disassociation time for disassociating the non-AP MLD from the first AP MLD if the non-AP MLD does not perform the link level roaming based on the at least one multi-link reconfiguration element.

11. An access point multi-link device (AP MLD) comprising:
at least one memory configured to store machine executable instructions; and
at least one processor communicatively coupled with the at least one memory and configured to execute the machine executable instructions to:
generate a frame including at least one multi-link reconfiguration element, wherein the at least one multi-link reconfiguration element includes at least one add link operation based on which a non-access point multi-link device (non-AP MLD) performs a link level roaming between the AP MLD and a second AP MLD, wherein both of the AP MLD and the second AP MLD belong to a seamless mobility domain; and
send the frame to the non-AP MLD to perform the link level roaming.

12. The AP MLD of claim 11, wherein the at least one processor is further configured to execute the machine executable instructions to:
determine a roaming time based on a predicted connectivity loss for the non-AP MLD with the AP MLD, wherein the AP MLD is a current AP MLD; and
update the frame to further include the roaming time indicating a recommended time of performing the link level roaming, wherein the roaming time is a timing synchronization function (TSF) time of the AP MLD by which, or at which, the non-AP MLD is expected to perform the link level roaming.

13. The AP MLD of claim 11, wherein the at least one processor is further configured to execute the machine executable instructions to:
update the frame to further include a seamless mobility domain identifier that identifies the seamless mobility domain.

14. The AP MLD of claim 11, wherein,
the frame includes a first multi-link reconfiguration element and a second multi-link reconfiguration element, the first multi-link reconfiguration element corresponding to a first target AP MLD that is the second AP MLD and the second multi-link reconfiguration element corresponding to a second target AP MLD, and
the at least one processor is further configured to execute the machine executable instructions to:
receive, from the non-AP MLD, an acceptance of the link level roaming corresponding to the first multi-link reconfiguration element; and
receive, from the non-AP MLD, a rejection of the link level roaming corresponding to the second multi-link reconfiguration element.

15. The AP MLD of claim 11, wherein the at least one processor is further configured to execute the machine executable instructions to:
update the frame to further include at least one delete link operation in the at least one multi-link reconfiguration element,
wherein the at least one delete link operation identifies one or more links of the AP MLD to be deleted when performing the link level roaming, and
wherein the at least one add link operation identifies one or more links of the second AP MLD to be added when performing the link level roaming.

16. The AP MLD of claim 11, wherein the AP MLD and the second AP MLD is identified in the frame by a respective AP MLD media access control (MAC) address.

17. The AP MLD of claim 11, wherein the at least one processor is further configured to execute the machine executable instructions to:
update the frame to further include a roaming command specifying a preference of the AP MLD for the at least one multi-link reconfiguration element, wherein the preference includes one of the link level roaming being mandatory, the link level roaming being preferred, the link level roaming being suggestive, and the link level roaming being neutral.

18. The AP MLD of claim 17, wherein the at least one processor is further configured to execute
the machine executable instructions to:
update the frame to further include a roaming reason field specifying a reason for the preference.

19. The AP MLD of claim 18, wherein the reason for the preference corresponds with one of a high load on the AP MLD, and a degraded quality of service (QoS) at the AP MLD.

20. The AP MLD of claim 11, wherein the at least one processor is further configured to execute the
machine executable instructions to:
update the frame to further include a disassociation imminent field specifying a disassociation time for disassociating the non-AP MLD from the AP MLD if the non-AP MLD does not perform the link level roaming based on the at least one multi-link reconfiguration element.
